(19) United States
(12) Patent Application Publication
(10) Pub. No.: US 2004/0047443 A1
(43) Pub. Date: Mar. 11, 2004

(54) Electron capture by magnetic resonance

(76) Inventor: Edwin L. Bondoc, Makati City (PH)

Correspondence Address: Edwin L Bondoc, Makati Central Box 3528, Post Office Box 1275, Makati City, PH

(21) Appl. No.: 10/433,701

(22) PCT Filed: Jan. 7, 2002
(86) PCT No.: PCT/PH02/00001

(30) Foreign Application Priority Data
Aug. 31, 2001 (PH) 1-2001-002207

(51) Int. Cl. G21G 1/00

(52) U.S. Cl. 376/156

(57) ABSTRACT

The process of capturing electron by subjecting proton to magnetic resonance until its magnetic moment is in opposite direction relative to the electron's magnetic moment. As soon as the particles' magnetic moments are opposite in direction, spinlocking technique is applied for a period of time to induce transmutation of the particles and the consequent reactions of the product with an adjacent particle or a group of particles and the release of energy.

### FIELD OF THE INVENTION

The invention pertains to the process of electron capture with the use of magnetic resonance by spin-locking the subatomic particles while their magnetic moments are in opposite direction.

### BACKGROUND OF THE INVENTION

All nuclei can be transformed by reactions with nucleons or other nuclei that collide with them. One of these transformations is called Beta Decay with three different modes, namely; electron emission, electron capture, and positron emission. Of the three modes, this invention relates about the phenomenon of electron capture but not through the decay process of an atom. Electron capture is an occurrence wherein a proton will capture an electron usually a 1s electron or the K level and the proton is converted into neutron (p⁺+e⁻→n^{o}). The hole left by the K-electron is filled by an electron from a higher level with the excess energy emitted in the form of X-ray. The mass difference between the progeny and the parent results to the production of energy and a neutrino (Alvarez, Physical Review vol. 54, 1938).

Another transformation in nuclear physics is called neutron capture. Neutron capture's probability is inversely proportional to the energy level of the neutron and therefore a thermal neutron has the highest probability capture. It also follows from theories that with very few exceptions the capture cross section should vary inversely as the velocity of the slow neutrons (Breit et al, Physical Review vol. 49, 1936). When a neutron is captured by a nucleus, the progeny has an increased mass number of 1 and will emit a particle, electromagnetic radiation or the fission of nucleus. If the thermal neutrons are captured by hydrogen nuclei, they produce deuterium by the reaction, n+p→d+γ. The binding energy of the deuteron is released in the form of a 2.223 MeV energy.

Nuclear Magnetic Resonance (NMR) is a powerful and theoretically complex analytical tool (see FIG. 1) but has number of important applications in various branches of chemistry and physics. NMR spectroscopy and NMR imaging have been widely used to analyze the electronic and molecular structure, motion, and chemical composition of a sample.

Protons, electrons, and neutrons possess spin. When the spins of these particles are not paired, the overall spin generates a magnetic dipole along the spin axis, and the intrinsic magnitude of the dipole is a fundamental property called the magnetic moment μ.

In quantum mechanical terms, the magnetic moment can align with an externally applied magnetic field strength Bₒ in only 2I+1 ways, either reinforcing or opposing Bₒ. The energetically preferred orientation has the magnetic moment aligned parallel with the applied field (spin +½) and is often given the notation α, whereas the higher energy anti-parallel orientation (spin −½) is referred to as β. The rotational axis of the spinning particle cannot be oriented exactly parallel (or anti-parallel) with the direction of the applied field Bₒ (defined in the coordinate system as about the z axis) but must precess about this field at an angle with an angular velocity given by the expression, ωₒ=γBₒ (the Larmor frequency, in Hz). The constant γ is called the gyromagnetic ratio and relates the magnetic moment μ and the spin number I, γ=2πμ/hI (h is Planck's constant).

In NMR, a weak oscillating field B₁ is superimposed on the strong constant field Bₒ (see FIG. 2), and its vector rotates with an angular velocity (ω) in a plane perpendicular to the direction of the field Bₒ. If the rate of rotation (ω) of the field B₁ is different from the Larmor frequency (ωₒ) of the precessing particle, the two rotating fields will be out of phase; the axis of the particle will successively be attracted and repelled by the superimposed field during complete revolutions and will wobble only slightly. When they are synchronized, however, a steady force will act on the magnetic moment of the particle. Energy at this time is absorbed by the particle, and then the angle of precession will change. There are two methods to produce the oscillating field B₁. One is the application of B₁ in continuous wave and the other is in trains of pulse.

In relation to the invention, the pulse type NMR is chosen to get the desired inversion. In the pulse type NMR, a range of frequencies +ω±1/tₚ are produced for the field B₁, enabling resonance to be simultaneously established with all the Larmor frequencies of the particles with 1/tₚ of +ω. The phase of each set of identical resonances is rendered coherent, which “tips” the macroscopic magnetic moment for each resonance away from Bₒ, by the angle θ defined by; θ=γB₁ tₚ (tₚ=pulse duration). A value of θ=90° is often referred to as a 90° pulse because of the angle the magnetic moment is changed, i.e. from the z axis into the xy plane. Pulses for which θ=180° would have the effect of completely reversing the direction of the magnetic moment μ.

Once the desired angle θ at resonant frequency is achieved, the magnetic moment returns to its equilibrium position aligned with the field Bₒ, ready for another pulse of B₁. This process of returning to an equilibrium energy distribution is called relaxation. The return of excited charged particle from the high energy to the low energy or ground state is associated with the loss of energy to the surrounding nuclei. Emission of radiation is insignificant because the probability of re-emission of photons varies with the cube of the frequency. At radio frequencies, re-emission is negligible. After a pulse of B₁, the particle is said to relax emitting rf signal which is then processed to produce the corresponding spectra in spectroscopy or image in MRI.

A technique employed sometimes in NMR to enhance NMR signal is spin-locking (U.S. Pat. No. 5,420,510 issued to Fairbanks et al. and U.S. Pat. No. 4,345,207 issued to Bertrand et al.). In order to spin-lock the magnetic moment, we first have to take it away from the direction of Bₒ. Once the magnetic moment is in the desired plane, we have to hold it there by introducing a new magnetic field Bₛₗ aligned with the desired plane. Bₛₗ is a fluctuating magnetic field applied at (or near) the resonant condition of the spins of the particle and could be continuous wave or composite pulse that has the same effect that of CW irradiation.

Magnetic resonance phenomenon is always applied to one of the unpaired subatomic particles. But in the case of atoms like ordinary hydrogen (which has two unpaired particles), magnetic resonance affects both proton and electron. In the absence of a magnetic field, the equilibrium orientations of these nuclear magnetic moments are random and the energies associated with different orientations of a nuclear moment are small. In the presence of a static magnetic field, these nuclear magnetic moments assume a certain allowed quantized orientations with respect to the static magnetic field. All the particles in our environment are always subjected to external magnetic field either enforced by the earth's magnetism or by a local magnetic field with a flux thickness equal to or more than the diameter of an atom, hence, their magnetic moments are always oriented and parallel to the ambient magnetic field. It is important therefore to consider the presence of background magnetic field that could affect the entire process.

Knowing the fact that all atoms are subjected to a magnetic field, in the case of hydrogen for example, its proton and electron will always have their respective magnetic moments (μₚ and μₑ) align parallel to each other and to the ambient magnetic field and oriented in the same direction. Both particles are attracted to each other relative to their charges but are also repelling each other because their magnetic fields are oriented in the same direction.

Electron Spin Resonance (ESR) is similar to NMR; the fundamental difference is that ESR is concerned with the magnetically splitting of electronic spin states, while NMR describes the splitting of nuclear spin states (usually proton). Moreover, ESR usually requires microwave-frequency radiation (GHz), while NMR is observed at lower radio frequencies (MHz).

Basic facts in physics remind us that in electrostatics, opposite charges attract and like charges repel and in magnetism, opposite poles attract and like poles repel. But in the case of hydrogen, the electron is held on its orbital because of a repulsive force although the attractive force due to their charges is strong.

### SUMMARY OF THE INVENTION

The repulsion problem of subatomic particles such as in hydrogen can be solved by inverting one of the particle's magnetic moment and by applying the spin-locking technique. The moment that their magnetic moments are parallel and opposite in direction, there is no other course of action but attraction subsequently transforming the particles and release energy. According to classical physics, the electron will spiral down into proton. In hydrogen, electron's velocity is 2.2×10⁶ m/s at an orbital radius of 5.3×10⁻¹¹ m while the proton's radius is about 1.2×10⁻¹⁵ m. If electron is the size of a pinhead, proton would be about 21 meters away described one author. The electron capture, therefore, is not instantaneous because of the particles' momentum and the distance between particles.

Ideally, all the hydrogen atoms exposed to NMR field in the method of this invention will be transformed to thermal neutron. This thermal neutron rich flux will then react with the adjoining unaffected hydrogen atoms and release additional energy. Repeating the NMR cycle will produce a continuous supply of neutron and energy by movement of either the particles or by the NMR system itself.

### BRIEF DESCRIPTION OF THE DRAWINGS

FIG. 1 is a block diagram of an FT-NMR Spectrometer;

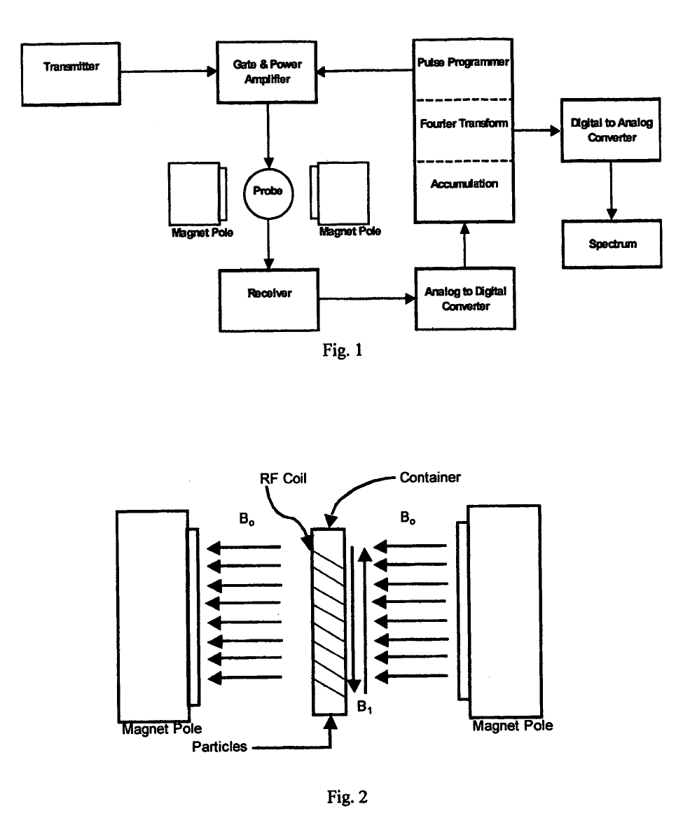

FIG. 2 is a schematic representation of NMR;

FIGS. 3A to 3D are graphic representations of the embodiment of electron capture according to the invention.

### DETAILED DESCRIPTION OF THE PREFERRED EMBODIMENT

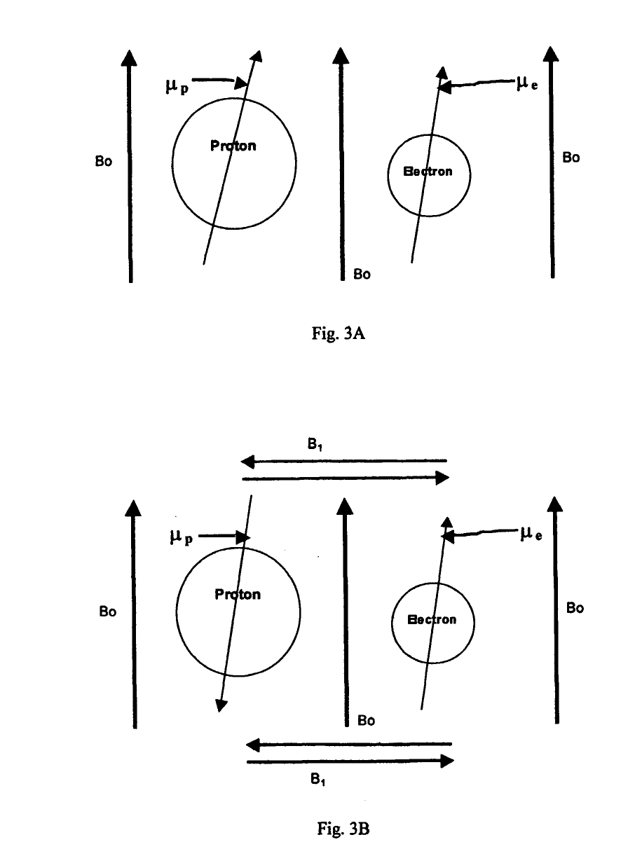

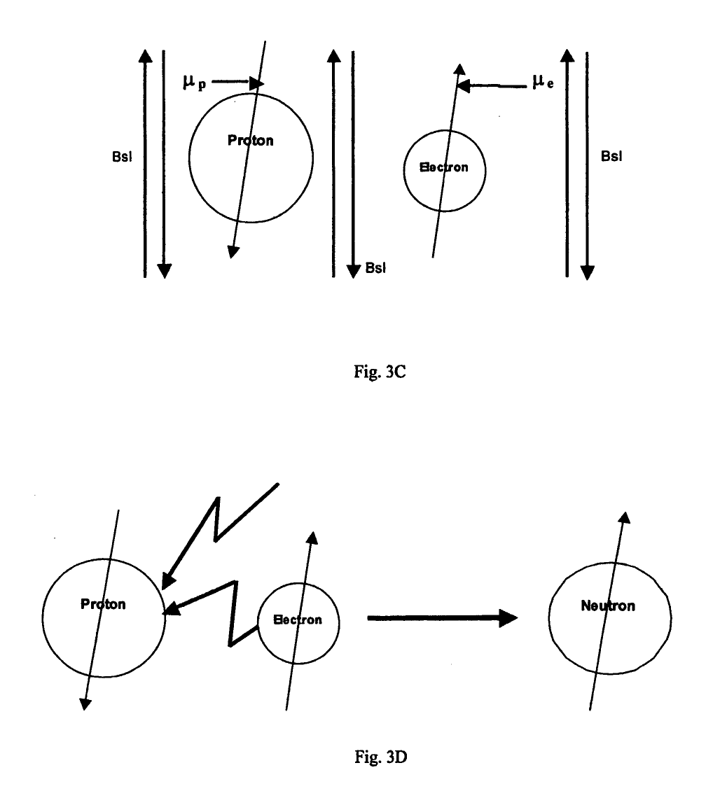

The invention detailed herein will use NMR instead of ESR to simplify the process description and equipment to be used. The particles to be subjected to NMR method of this invention are initially confined in a container (see FIG. 2 and FIG. 3A) to be immersed in a magnetic field Bₒ. For simplicity, hydrogen's proton and electron will be used for this detail although other atoms could be used in this invention. When stable condition is reached, oscillating field B₁ is applied to invert the protons in the desired angle θ where θ=γB₁tₚ (see FIG. 3B) and could be from 90 to 180 degrees but preferably 180 degrees. At 90 degrees, the proton's spin will sometimes be almost opposite that of the electron since it wobbles around that angle. To minimize time and maximize magnetic force of attraction, the angle of 180 degrees is ideal for the process.

As soon as the protons attained inversion (i.e. 180 degrees) and while the electron is held aligned and in the direction of the field Bₒ, spin-locking magnetic field Bₛₗ is applied to hold the direction of the magnetic moments of proton and electron always opposite each other (FIG. 3C) for duration tₛₗ longer than proton's relaxation time T₁ or T₂. The rate of the field Bₛₗ should be equal to or greater than the relaxation rate (1/T₁ or 1/T₂) of the spin but for practical purposes, the rate should be greater than the relaxation rate. The field Bₒ is stopped at the same time that the field Bₛₗ is applied. One way of stopping the field Bₒ is to use a non-permanent type of magnet to produce the field or an electromagnet type so that by switching off the current, the field is stopped. At 180 degrees inversion, the electromagnet that produces the field Bₒ could also be used to produce the spin-locking magnetic field Bₛₗ. To do this, the electrical system should be configured such that in the initial field Bₒ a direct current is used to produce one directional steady field and for the field Bₛₗ an alternating current is used for the oscillating field. Another way of producing Bₛₗ for 180 degrees inversion is to use another coil apart from the electromagnet producing Bₒ but is parallel to Bₒ. The direction of the field Bₛₗ is thus always maintained parallel to the magnetic moment of proton. Applying the field Bₛₗ for a duration longer than the relaxation time T₁ or T₂ will make the electron to eventually combine with proton resulting in the formation of neutron (p+e→n) releasing energy (see FIG. 3D).

The thermal neutron produced will be captured by an adjacent atom which was not subjected to the NMR process and release additional energy. Additional method could be used to enhance neutron capture such as moving the particles mechanically or by introduction of heat or electromagnetic radiation. Around the thermal neutron rich flux, several reactions could take place such as but not limited to; n+p→²H, n+²H→³H, n+³H→⁴He+v, and 2n+2p→⁴He; where p=proton, n=neutron, ²H=deuterium, ³H=tritium, v=neutrino, ⁴He=helium.

Repeating the steps mentioned above in multiple units or by applying the method in staggered basis for multiple units will result in a continuous production of neutron and energy. This method can be used for inversion of electron or neutron for energy production or transmutation but other frequencies will be used because of the different Larmor frequency for each particle or atom.

1. A magnetic resonance system which inverses the orientation of hydrogen's proton relative to its electron particle and holding it by spin-locking the particles for a certain duration until the reactions are achieved which comprises the following steps:
a) applying a steady field Bₒ to the spins;
b) applying an RF field pulse B₁ to spins to attain a tip angle θ of 90 degrees or more but preferably 180 degrees;
c) applying a field Bₛₗ with a rate equal to or greater than the relaxation rate (1/T₁ or 1/T₂) of the spin and generally should be greater, either continuous wave or pulse to spin-lock the spins after attaining the Larmor frequency in b) and at the same time stopping the field Bₒ;
d) applying the field Bₛₗ in c) for duration longer than the spin's relaxation time T₁ or T₂.

2. The method of claim 1 to produce the reaction, p+e→n and the release of energy (p=proton, e=electron, and n=neutron).

3. The method of claim 1 to produce the reaction, n+p→²H (²H=deuterium) and the release of energy where n is the product of claim 2 and p is adjacent to the product of claim 2.

4. The method of claim 1 to produce the reaction, n+²H→³H (³H=tritium) and the release of energy where n is the product of claim 2 and ²H is the product of claim 3 or is adjacent to the product of claim 2.

5. The method of claim 1 to produce the reaction, n+³H→⁴He+v (⁴He=helium and v=neutrino) and the release of energy where n is the product of claim 2 and ³H is the product of claim 4 or is adjacent to the product of claim 2.

6. The method of claim 1 to produce the reaction, 2n+2p→⁴He (⁴He=helium) and the release of energy where n is the product of claim 2 and p is adjacent to the product of claim 2.

7. The method of claim 1 to inverse the orientation of electron or neutron for transmutation and the release of energy.
